(19) United States
(12) Patent Application Publication
(10) Pub. No.: US 2023/0061315 A1
(43) Pub. Date: Mar. 2, 2023

(54) METHODS FOR PRODUCING CORNSTARCH

(71) Applicant: Japan Corn Starch Co., Ltd., Tokyo (JP)

(72) Inventors: Vijay SINGH, Urbana, IL (US); Yuri SAKAKIBARA, Tokyo (JP)

(21) Appl. No.: 17/410,263

(22) Filed: Aug. 24, 2021

(51) Int. Cl. C08B 30/04

(52) U.S. Cl. CPC C08B 30/044

(57) ABSTRACT

The present disclosure provides a method for producing cornstarch, which can efficiently produce cornstarch by using grain dust as a raw material and can suppress wear of equipment.

### TECHNICAL FIELD

The present invention relates methods for producing cornstarch and for separating iron from corn material.

### BACKGROUND AND SUMMARY

Methods for producing cornstarch are known in the art, for instance a method for separating and producing cornstarch by steeping grains in acid (sulfurous or other), alkali, or water.

Corn (all types of corn, including dent, waxy, high amylose, colored corn or other types), used in the production of cornstarch contains broken grains and nonstandard grains that are generated by impact during transportation. In the production of cornstarch, it is common to use selected grains that exclude the broken grains and nonstandard grains. In this case, the excluded grains can include broken grains, non-standard grains, or a combination thereof.

Broken grains and non-standard grains generally occur at about 0.05-20 mass % of a raw material for manufacturing starch. Although this represents a small percentage of the total raw materials, the occurrence can amount to a few dozen to hundred tons per day. The broken grains and nonstandard grains include 20% by mass or more of starch and is typically utilized as feed without effectively using a considerable amount of starch.

The present disclosure provides a novel method for efficiently producing cornstarch by using grain dust as a raw material. For instance, the present disclosure provides the following aspects.

First, a method for producing corn starch is provided. The method comprises a step of sieving grain dust into a first fraction remaining on the sieve and a second fraction passing through the sieve utilizing a sieve having a mesh size of 0.8 mm to 1.4 mm, a step of dividing the first fraction in the fine granules and pericarp by air separation, a step of steeping the granules in a first sulfuric acid-containing steep water, a step to separate the iron powder from the second fraction using first magnetic separator, a step of steeping the second fraction after separating the iron powder in the second sulphite containing steep water, and the step of mixing fine granules after the step of steeping in the first sulphite containing steep water and the second fraction after the step of steeping in the second sulfite-containing and removing foreign matter from the mixture.

In some embodiments, the method provides that the first magnetic separator is selected from the group consisting of an electromagnetic separator, a drum magnet, a non-drum magnet, and any combination thereof.

In some embodiments, the method further comprises a step of separating iron powder from the second fraction after the step of immersing in the second sulfite-containing immersion liquid using a second magnetic separator.

In some embodiments, the method further comprises a step of selecting corn and separating it into foreign matter, whole corn, and the grain dust described above.

In some embodiments, the method further comprises a step of mixing the sized granules with the fine grains before the step of steeping the fine granules in the first sulfite-containing steep water.

According to the present disclosure, it is possible to efficiently produce cornstarch by using grain dust as a raw material. Further, the described methods for producing cornstarch can advantageously suppress wear of equipment.

### DRAWINGS

FIG. 1 shows the flow of the manufacturing method of the cornstarch in an embodiment of the present disclosure.

FIG. 2 shows the flow of the manufacturing method of the cornstarch in an embodiment of the present disclosure.

### DETAILED DESCRIPTION

Hereinafter, particular embodiments of the present disclosure are described. The following embodiments are merely exemplary to illustrate the invention and are not intended to limit the invention to particular embodiment alone. The present invention can be implemented in various aspects as long as it does not deviate from spirit of the invention.

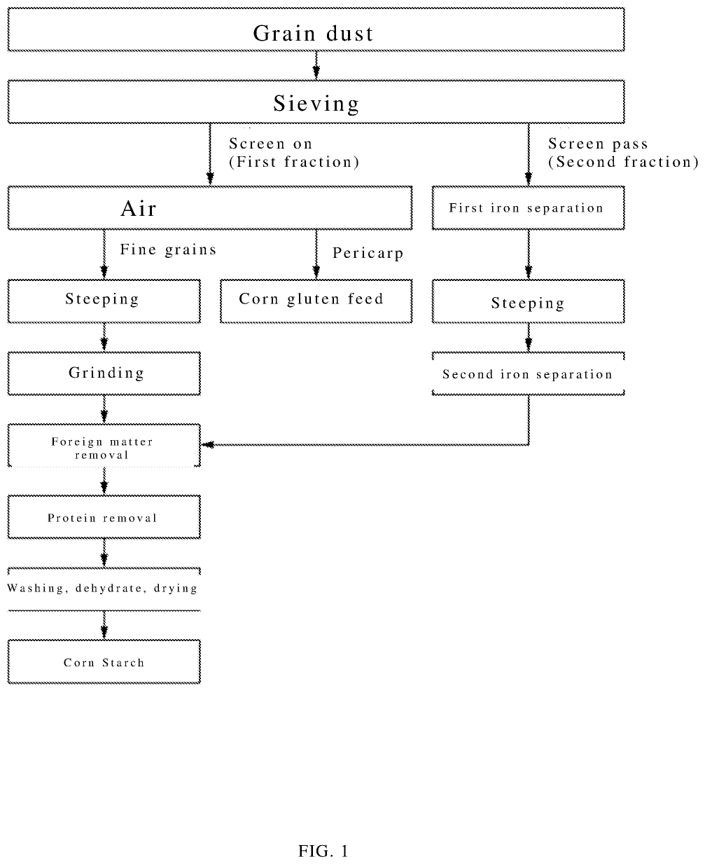

FIG. 1 is a diagram showing a flow of a manufacturing method of a corn starch in one embodiment of the present disclosure.

The method for producing cornstarch according to an embodiment of the present disclosure comprises a step of sieving grain dust. In an aspect, the sieving comprises using a sieve having a mesh size of 0.8 mm to 1.4 mm. The grain dust can be sieved into a first fraction, wherein the first fraction remains on the sieve, and a second fraction, wherein the second fraction passes through the sieve.

The method comprises a step of dividing the first fraction in the fine grains and pericarp by air separation, a step of steeping the granules in a first sulfuric acid-containing steep water, a step to separate iron powder from the second fraction using first magnetic separator, a step of steeping the second fraction after separating the iron powder in a second sulphite containing steep water, and a step of mixing fine granules after the step of steeping in the first sulphite containing steep water and the second fraction after the step of steeping in the second sulfite-containing steep water, and removing foreign matter from the mixture.

As shown in FIG. 1, the method for producing cornstarch according to an embodiment of the present disclosure may further comprise a grinding step between a step of steeping the fine grains in a sulfurous acid-containing steep water and a step of removing foreign matter from the mixture. Further, a protein removing step and a washing, dehydrating, and drying step may be included after the step of removing the foreign matter from the mixture. The second fraction of the fine grains comprises the step of separating the iron powder from the second fraction using a second magnetic separator during the process of removing material from the step and the mixture is steeped in a sulfuric acid-containing dip may be good. Hereinafter, a method for producing cornstarch according to an embodiment of the present disclosure will be described based on the flow shown in FIG. 1.

Grain Dust—Grain that is the source of the grain dust used as a raw material in the present embodiment is made of corn. The starch content of the grain dust varies depending on the grain transportation conditions, e.g. to 20-80 mass % with respect to the total mass of the grain dust.

Grain dust is generally understood to be material removed in selective processes of grain as a raw material for the manufacture of starch (e.g., cornstarch) without being used. Also, grain dust can comprise raw material for manufacturing starch in the selective step of corn, generally after a shifter (e.g. sieve) is used. For example, using a mesh opening of 17 mm and 3.5 mm sieve, the material left on the 3.5 mm sieve is a usually whole corn, the material remaining on the 17 mm sieve is non-standard grain, and the material that passed through a 3.5 mm sieve is broken grain.

Broken grains include broken grains and stems other than seeds that are generated via impact during transportation of grains. Due to the broken grains being too fine, they are typically removed without being used in the grain selection process for starch production.

When fine grains such as broken grains are contained in the raw material, various undesirable events may be observed. First, in the steeping step without using a stirrer, the grain is submerged in the sulfite-containing steep water. However, when the broken grains are contained, the sulfite-containing steep water is channeled in the raw material containing the broken grains. As a result, the sulfite-containing steep water enters only in a certain flow path generated in the raw material, and it becomes difficult to spread it throughout the grain, leading to poor steeping.

Second, when the sulfite-containing steep water and the grain are separated after the steeping step, if the proportion of broken grain grains is large, the flow path of the steep water can be restricted and the liquid is difficult to discharge from the steeping tank.

Third, most of the broken grain grains are discharged together with the sulfurous acid-containing steeping liquid when the sulfite-containing steeping liquid is discharged from the steeping tank. Therefore, this discharge cannot be used in the subsequent starch recovery step.

When using a 3.5 mm opening sieve, the size of the broken grain is less than 3.5 mm. Non-standard grains are non-standard grains of a certain size or larger, and are excluded without being used as grains that may cause deterioration in quality and starch yield in the grain selection process in starch production. Most of the non-standard grains comprise cob and/or stem which have a low starch content, and this material may not be sufficiently crushed in the coarse crushing and grinding steps following the steeping step, which may cause clogging of pipes. When using a mesh opening 17 mm sieve, the size of non-standard grains are larger than 17 mm or equal. Broken grains and non-standard grain is intended to occur about 0.1-20 mass. % of a raw material for manufacturing starch. Although this may seem to only represent a small percentage of the total raw materials, the total amount of occurrences per day may equal a few dozen to hundreds of tons.

In an embodiment, a mesh opening 3.5 mm sieve can be used, and broken grains having a size of 3.5 mm or less that have passed through the sieve are defined as grain dust.

Sieve Separation—As shown in FIG. 1, grain dust can be sieved using an opening of 0.8 to 1.4 mm sieve, resulting in a first fraction which remains on the sieve and a second fraction which passes through the sieve.

When the first fraction and the second fraction are sieved using a mesh opening 0.8 to 1.4 mm sieve, the first fraction comprising fine corn grains and the second fraction comprising iron powder can thereafter be separated. By separating in this manner, it is possible to efficiently perform appropriate processing for each fraction, such as by using air separation of the first fraction and iron powder separation of the second fraction. As a result, it is possible to improve the final corn yield.

Air separation of the first fraction—The first fraction mainly contains fine grains of corn and pericarp. The first fraction can be separated into fine grains and pericarp by air separation. The conditions of air separation can vary according to the equipment size or the processing amount of the first fraction. For example, when the processing amount is 600 kg/hour, the air volume at the time of wind selection can be between 18 to 35 m³/min. An air separator manufactured by Technowashino Co., Ltd. can be used as an exemplary separator.

Fine grains have a particle size of 0.8 to 3.5 mm. The separated pericarp can be mixed to corn gluten feed and used as a feed.

The proportion of particles of 0.8 to 3.5 mm is 90% by mass or more with respect to the total mass of fine grains. In various embodiments, the proportion of particles that are 0.8 to 3.5 mm can be measured as follows. A sieve with a mesh opening 0.8 mm and a sieve with a mesh opening 3.5 mm can be overlapped. Fine particles are passed through the sieves. The mass of the particles remaining on the 0.8 mm sieve can be measured. The proportion of particles against the total mass of fine grains can be calculated.

Steeping of the first fraction—The fine grains separated from the first fraction can be steeped in a sulfurous acid-containing steeping liquid. As a result, the bond between the starch and the protein in the fine grains can be efficiently cleaved, and the starch can be efficiently separated from the fine grains. In an embodiment, sulfite includes sulfite, hyposulfite, pyro sulfite, and sodium salt, potassium salt, magnesium salt, and calcium salt thereof.

The sulfurous acid in the sulfurous acid-containing steeping liquid is preferably contained in an amount of 50 ppm to 2000 ppm with respect to the mass of water contained in the sulfurous acid-containing steeping liquid. Some lactic acid could also be present in the steeping liquid. Lactic acid concentration could be 0.01 to 6.0% or more. This is because the bond between the starch and the protein in the fine grains can be efficiently cleaved. If the amount of sulfite in the sulfite-containing steeping liquid is 50 ppm or more with respect to the mass of water contained in the sulfite-containing immersion liquid, the time of the steeping step is not too long, and cornstarch can be efficiently produced.

The algae-proof and antifungal properties of processed cornstarch can be maintained and microbial contamination can be prevented. When the sulfurous acid in the sulfurous acid-containing immersion liquid is 2000 ppm or less, economically it is possible to perform the production of corn starch. The sulfurous acid in the sulfurous acid-containing immersion liquid is more preferably 200 ppm to 1800 ppm, still more preferably 600 ppm to 1200 ppm, based on the mass of water contained in the sulfurous acid-containing steeping liquid.

The proportion of sulphite-containing steeping liquid in the steeping step is preferably 90% to 250% quality weight by mass relative to the mass of the fine grains. This is because the mixing efficiency of the fine grains and the sulfurous acid-containing steeping liquid is excellent. When the ratio of the sulfurous acid-containing steeping liquid is 90% by mass or more with respect to the mass of the fine grains, the bond between the starch and the protein in the fine grains can be sufficiently cleaved. When the ratio of the sulfurous acid-containing steeping liquid is 250% by mass or less, the starch yield of cornstarch obtained by the method for producing cornstarch is sufficient. The proportion of sulphite-containing steeping liquid with respect to the mass of granules 95% to 230% by weight preferable and still more preferably 100 to 200 mass %.

The temperature of the sulfurous acid-containing steeping liquid in the steeping step is preferably between 40° C. to 65° C. It is possible to efficiently break the di-sulfide bonds of protein matrix present in the grains, and more efficiently recover starch. When the temperature of the sulfurous acid-containing immersion liquid is 40° C. or higher, the disulfide bonds of the protein matrix in the fine grains can be sufficiently cleaved, and a sufficient bactericidal effect can be obtained. When the temperature of the sulfurous acid-containing steeping liquid is 65° C. or lower, the disulfide bonds of the protein matrix in the fine granules can be efficiently cleaved, and gelatinization of the starch does not occur. The temperature of the sulfurous acid-containing steeping liquid is more preferably 50° C. to 55° C.

The mixing time of the fine grains and the sulfurous acid-containing steeping liquid in the immersion step is preferably 1 hour to 48 hours, depending on the temperature of the sulfite-containing steeping liquid and the sulfurous acid concentration. This is because the bond between the starch and the protein in the fine grains can be efficiently cleaved. When the mixing time of the sulfurous acid-containing immersion liquid is 1 hour or more, the bond between the starch and the protein in the fine granules can be sufficiently cleaved. When the mixing time of the sulfurous acid-containing immersion liquid is 48 hours or less, the bond between the starch and the protein in the fine granules can be efficiently cleaved, which is economical from the viewpoint of calorific value. The mixing time of the sulfurous acid-containing immersion liquid is more preferably 3 hours to 20 hours, or preferably 8 hours to 16 hours.

In the steeping step, it is preferable to use a steeping tank having a hot water or a cold water circulation jacket capable of keeping the temperature of the sulfurous acid-containing steeping liquid constant.

After the steeping step, the sulfurous acid-containing steeping liquid is withdrawn from the steeping tank. The fine grains swollen by steeping may be ground to form a slurry. Grinding can be performed by a grinder such as a disc type grinder or an impact type grinder such as a disintegrator.

First Iron Powder Separation—Since the second fraction can contain a large amount of iron powder, the equipment may be susceptible to being prematurely worn out if the second fraction is directly added to the cornstarch manufacturing process. Therefore, the iron powder can be separated from the second fraction.

Iron powder magnetic force at the time of separation is preferably equal to or greater than 5000 gauss, with between 8000 and 12000 gauss still more preferable. A first magnetic separator is used to separate the iron powder. As the first magnetic separator, electromagnetic partial release device (e.g., Nippon Magnetic Co., electromagnetic separator CG-type) or a drum-type magnet (e.g., Kanetek Co., drum magnetic separator KDS) can be used.

If the iron powder is separated after the second fraction after it is steeped in the sulfurous acid-containing steeping liquid, the iron powder separation efficiency tends to decrease. There is also a possibility of accelerating the wear of the equipment until the second fraction is immersed. Therefore, in the second fraction, the iron powder can be separated before being steeped in the sulfurous acid-containing steeping liquid (e.g., a state in which the second fraction is dry). When the iron powder is separated while the second fraction is dry, most of the iron powder contained in the second fraction can be separated.

The iron powder separation rate in the iron powder separation step is preferably 78% by mass or more, and more preferably 85% by mass or more, based on the mass of the iron powder contained in the second fraction before the iron powder separation. By using an iron powder separation rate at least 78% relative to the mass of the iron powder contained in the second fraction before iron powder separating, it is possible to suppress the wear of the equipment used for the production of corn starch. The upper limit of the separation rate of the iron powder contained in the second fraction is not particularly limited, and may be 98% by mass or 99% by mass.

Immersion of the second fraction—The second fraction from which the iron powder is separated by the first magnetic separator can be steeped in the sulfurous acid-containing steeping liquid. As the sulfurous acid-containing steeping liquid, the above-mentioned components can be used. The ratio of the sulfurous acid-containing steeping liquid is preferably 200% by mass to 500% by mass with respect to the mass of the second fraction. This is because the mixing efficiency of the second fraction and the sulfurous acid-containing steeping liquid is excellent. When the proportion of sulphite-containing steeping liquid is 200 mass % or more to the mass of the second fraction mass, the second fraction and the sulphite-containing immersion liquid can be stirred enough by agitator described later.

The proportion of sulfite acid-containing steeping liquid is preferably 220% to 450 mass % with respect to the mass of second fraction and further preferably 250% to 400 mass %.

The temperature of sulphite-containing steeping liquid in the steeping step can be set to the same temperature range as the above-described steeping process.

In the steeping step, the mixing time of the second fraction and sulphite-containing steeping liquid is preferably 1 hours to 48 hours, although it may depend on the degree and sulfite concentration. This is because the bond between the starch and the protein in the second fraction can be efficiently cleaved. When the mixing time of the sulfurous acid-containing steeping liquid is 3 hours or more, the bond between the starch and the protein in the second fraction can be sufficiently cleaved. When the mixing time of the sulfurous acid-containing steeping liquid is 24 hours or less, the bond between the starch and the protein in the second fraction can be efficiently cleaved, which is economical from the viewpoint of calorific value. The mixing time of the sulfurous acid-containing steeping liquid is preferably 2 hours to 20 hours, and further preferably 4 hours to 8 hours.

The steeping step of the second fraction is preferably carried out with stirring. This is because even if the particle size of the second fraction is small, mixing and circulation can be performed without separating from the sulfurous acid-containing immersion liquid. The stirring speed can be appropriately set depending on the size of the reactor that is used. For example, if the reactor diameter is 3 meters, the rate of stirring is preferably 5 to 50 rpm. When the stirring speed is 5 rpm or more, the second fraction does not precipitate, the steeping efficiency can be improved, and the second fraction can be used in the subsequent steps without leaving it in the reactor. When the stirring speed is 50 rpm or less, it is possible to suppress the occurrence of excessive power cost.

When the steeping step of the second fraction is performed while stirring, a reactor having a hot water or a cold water circulation jacket capable of keeping the temperature of the sulfurous acid-containing steeping liquid constant and agitating with a stirrer preferable can be used. As the stirrer, it is preferable to use a shaft rotary stirrer such as a propeller type. A circulation type stirrer can also be used, but it may be advisable to determine whether or not the circulation type stirrer can cope with the change in the viscosity of the mixed liquid in the steeping step.

Separation of second iron powder—It is preferable to further separate iron powder from the second fraction after the steeping step. A second magnetic separator can be utilized for separation of the iron powder. As the second magnetic separator, a wet line magnet (for example, a liquid line magnet filter manufactured by Kyowa Stainless Co., Ltd.) can be used. A wet type line magnet may be disposed in the piping connected to the reactor to steep the second fraction in the sulphite containing steeping liquid. The second fraction after the steeping step is discharged from the reactor, and the second fraction flows through the pipe, so that the iron powder is separated from the second fraction by the line magnet arranged in the pipe.

By performing the second iron powder separation, the amount of iron powder contained in the second fraction can be further reduced. Since a majority of the iron powder has likely already been separated from the second fraction via the first iron powder separation, the iron powder can be efficiently separated even further by using a wet line magnet, and it can reduce frequency of washing the second magnetic separator.

Foreign matter removal—A mixture of the products from the first fraction (e.g., the sulfurous acid-containing steeping liquid and the fine grains) and a mixture of the products from the second fraction (e.g., the sulfite-containing steeping liquid and products after the reduction of iron powder from the iron powder separations), also known as “fine grains and a second fraction, can undergo a foreign matter removing step.

The foreign matter removing step can remove foreign matter such as peels, fibers, sand, and metal powder which cannot be separated by the first and second magnetic separators from the mixture of the fine grains and the second fraction. The foreign matter removing step can include at least one of a filtering step by a screen mesh and a removing step by centrifugation. The filtering step by the screen mesh comprises a process of removing foreign matter which has constant diameter (e.g., a mesh size of screen mesh) or more in the mixture by passing through the screen mesh. A screen mesh opening used in the filtration process is preferably 25 μm to 250 μm. A plurality of steps may be combined so that the opening is gradually reduced in order for the foreign matter to be preferably removed. If the screen mesh opening is 25 μm or rougher, the time for the screen mesh to pass through is not too lengthy and is advantageously economical. If the screen mesh opening is 25 μm or finer, the foreign matter removal performance is sufficient. The screen mesh opening in the present embodiment is preferably 32 μm to 150 μm, and even more preferably 38 μm to 75 μm. When a plurality of filtration steps using a screen mesh are combined, for example, the mixture may be passed through opening 125 μm to remove large foreign matter, and then passed through opening 75 μm to remove fine foreign matter.

The removal step by centrifugation is a step of removing foreign substances having a higher specific density such as sand and metal from the mixture of the fine grains and the second fraction by centrifugation. Specifically, by using a centrifuge such as a degritting cyclone and a hydrocyclone, it is possible to remove foreign substances having a large specific density such as sand and metal from the mixture of the fine grains and the second fraction.

Protein removal—The protein removal step is a step of removing protein from a mixture of fine grains and a second fraction by a difference in specific gravity to leave starch. Specifically, the protein can be removed by using a centrifuge. In particular, when the mixture of the fine granules and the second fraction is put into the centrifuge, the protein having a light specific density flows to the overflow, and the starch having a heavy specific density flows to the underflow, so that the protein should be removed. As the centrifuge used in the protein removal step, a nozzle separator, a hydrocyclone, or the like can be used.

Washing, dehydration and drying—The washing step comprises a step of washing the precipitate containing starch that has undergone a protein removal step, if necessary, with water. For example, in an embodiment, a plurality of hydrocyclones can be connected, one of which is charged with a precipitate that has undergone a protein removal step, and the other is charged with water, and the starch is washed by a countercurrent method. According to this washing step, proteins can be further removed from the precipitate, and other impurities such as proteins, fibers, and oils having a lighter specific density than starch can also be removed.

The dehydration step comprises a step of removing water from the precipitate that has undergone the washing step, and can be taken when necessary as cornstarch powder. The dehydration step can be performed by dehydration by filtration and centrifugation, followed by drying with an indirect heating type dryer or the like. Optionally, the dehydration process can be omitted from a manufacturing method for cornstarch.

The ratio of protein contained in cornstarch that has undergone the washing step and the dehydration step is preferably 0.3 to 0.8% by mass in terms of dry mass with respect to the dry mass of cornstarch. When protein content is not more than 0.8 mass % by dry weight relative to the weight of starch, the load in the purification process after saccharification of corn starch is small. The percentage of protein contained in cornstarch preferably is small. If protein is less than 0.8 mass % by dry weight with respect to the dry weight of corn starch, the increase in cost due to such increase the amount of water in the washing step may not be necessary.

As described above, cornstarch can be efficiently obtained from grain dust by the method for producing cornstarch of the present embodiment. Therefore, cornstarch can be produced in a higher yield as compared with the conventional method for producing cornstarch which does not use grain dust as a raw material. Further, since the iron powder contained in the grain dust can be efficiently separated, the wear of the equipment can be advantageously suppressed.

Corn starch obtained by the production method of the corn starch of the present embodiment, including the starch seen, the entire corn starch weight (dry weight) with respect to the proportion of the starch 97.0 to 99.9 quality is mass %. The cornstarch that has undergone the dehydration step is a powder, and its particle size is 5 to 20 μm.

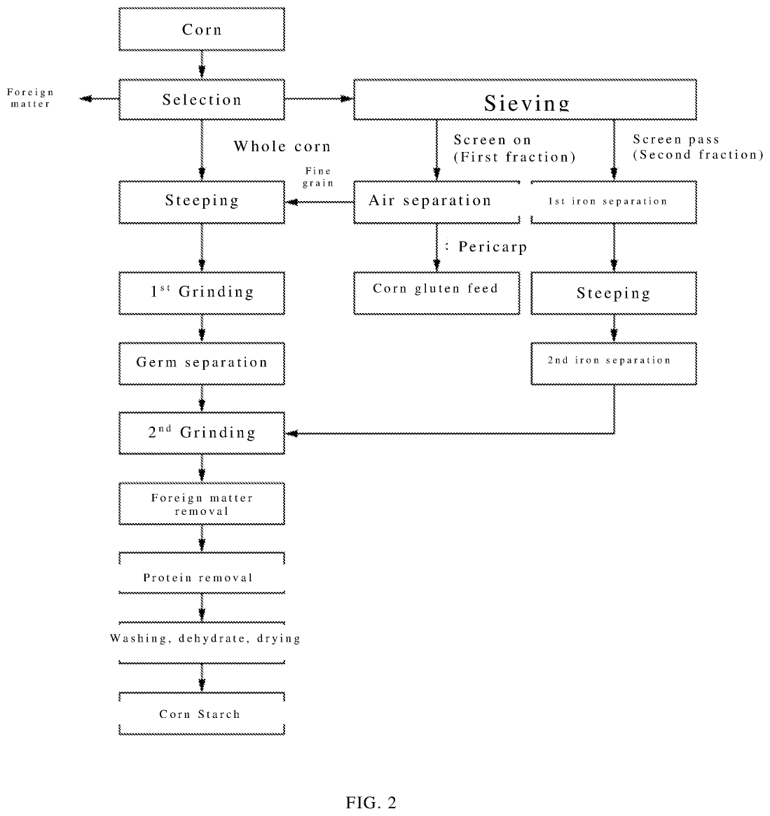

FIG. 2 is a diagram showing another embodiment of the present disclosure for producing cornstarch. In this embodiment, both whole corn (obtained by selecting corn) and grain dust are used as raw materials.

Specifically, the whole corn obtained by selecting corn and the fine grains obtained by air separation in the first fraction can be mixed and steeped in a sulfurous acid-containing steeping liquid. Regarding the operations after the step of steeping in the sulfurous acid-containing steeping liquid, the same operations as those described in the first embodiment can be performed. The second fraction can be obtained through the iron powder separation step and the steeping step in the sulfite-containing steeping liquid described in the first embodiment, and is mixed with the whole corn and fine grains before the foreign matter removing step to remove the foreign matter.

The particle size of whole corn is 3.5 to 5.0 mm. The proportion of particles in the whole corn of 3.5 to 5.0 mm is 90% by mass or more with respect to the total mass of the whole corn particles. In the present disclosure, the proportion of particles with a particle size of 3.5 to 5.0 mm can be measured as follows. An opening 3.5 mm sieve and a 5.0 mm mesh sieve are overlapped and passed through the whole corn, and the mass of the particles remaining on the 3.5 mm sieve is measured. The mass of the particles remaining on the 3.5 mm sieve is calculated as the proportion of the particles having a particle size of 3.5 to 5.0 mm.

Since germs are included in the whole corn, it is preferable that after the steeping step, the whole corn is coarsely pulverized. To the extent that the germs are not crushed, the germs can be separated by a fluid cyclone or the like, and then ground. By combining with the conventional method for producing cornstarch using whole corn as a raw material in this way, the yield of cornstarch can be improved more efficiently.

### EXAMPLES

Hereinafter, the present invention will be described in more detail with reference to Examples. In the examples, the operations after the foreign matter removing step are also individually performed so that the yields of the cornstarch of each of the first fraction and the second fraction are clarified. However, the present invention is not limited to this, fine grains obtained from the first fraction and the second fraction was mixed, out to perform the subsequent foreign matter removing step after as possible.

### Example 1

Approximately 100 kg of grain dust (e.g., corn dust in the instant example) was sieved using a shifter (manufactured by SW-ECO, circular vibrating sieve) having an opening of 1.2 mm. The first fraction remaining on the shifter equaled 46 kg, and the second fraction that passed through the shifter equaled 54 kg. The amount of iron powder contained in the second fraction was 12.8 g.

The first fraction was separated into fine grains and pericarps using an air separator (manufactured by KICE, multi-aspirator 6DT4). The fine grains weighed 36.8 kg and the pericarp weighed 9.2 kg. About 40.5 kg of sulfurous acid water (sulfurous acid concentration is 500 ppm with respect to the total mass of water) was added to the 36.8 kg fine grains in a stainless steel tank having a capacity of 500 L. This combination was steeped at 50° C. for 48 hours.

After steeping, the fine grains were grinded by a grinding mill (QCG SYSTEMS LLC Co., Grinding Mill) and foreign matter was removed by passing a screen mesh (SW-ECO, Inc., circular vibration sieve). The dry matter-equivalent mass of the removed foreign matter was 11 kg.

Thereafter, the first fraction was washed with water, protein separated by centrifuge (Wanner Engineering Inc Co., Hydra-Cell), and further washed with water. The first fraction was then dehydrated by centrifugal separator (Kokusan Co., upper discharge type centrifugal separator H-130E) and dried by a dryer (Espec Corp., a hot air dryer LC-114). Obtained cornstarch was 25 kg.

The second fraction was placed into an electromagnetic separator (electromagnetic separator CG-180X-1 manufactured by Nippon Magnetics Co., Ltd.) in order to separate iron powder. The amount of iron powder contained in the second fraction after separating the iron powder was 0.3 gram, and the iron powder separation rate was 95% by mass.

About 162 kg of sulfur water (sulfurous acid concentration on the total weight of water 500 against ppm) was added to the 54 kg of the second fraction. This combination was steeped for 4 hours with stirring at 120 rpm by agitator (Satake of chemical industry Co., Ltd., a small mixer A720) and kept at 50° C.

After steeping, the second fraction was passed through the screen mesh (SW-ECO, Inc., circular vibrating sieve) to remove the foreign matter. The dry matter-equivalent mass of the removed foreign matter was 21 kg.

Thereafter, the second fraction was washed with water, protein separated by centrifuge (Wanner Engineering Inc. Co., Hydra-Cell), and further washed with water. The second fraction was then dehydrated by centrifugal separator (Kokusan Co., upper discharge type centrifugal separator H-130E) and dried by a dryer (Espec Corp., a hot air dryer LC-114). Obtained cornstarch was 31 kg.

From the above results, the yield of cornstarch recovered from the grain dust was 56% by mass with respect to the total mass of the grain dust.

### Comparative Example 1

About 300 kg of sulfur water (the sulfite concentration of water to 500 ppm to total weight) was added to 100 kg of corn dust. This combination was steeped for 4 hours while stirring with an agitator (manufactured by Satake Chemical a small mixer A720) and kept at 50° C.

After steeping, the corn dust was passed through a screen mesh (SW-ECO, circular vibrating sieve) to remove foreign matter. The mass of the removed foreign matter in terms of dry matter was 51 kg.

Thereafter, the corn dust was washed with water, protein separated by centrifuge (Wanner Engineering Inc. Co., Hydra-Cell), and further washed with water. The corn dust was then dehydrated by centrifugal separator (Kokusan Co., upper discharge type centrifugal separator H-130E) and dried by a dryer (Espec Corp., a hot air dryer LC-114). Obtained cornstarch was 45 kg.

From the above results, the yield of cornstarch recovered from the grain dust was 45% by mass with respect to the total mass of the grain dust.

### Comparative Example 2

Corn dust was separated by the air separator (Kice Co., multi-aspirator 6DT4). The overflow (mainly containing foreign matter) was 37.6 kg, and the underflow (mainly containing fine grains) was 62.4 kg. For overflow, 2.5 kg of fine grains was mixed in the overflow and 25 kg of foreign matter including pericarp was mixed in the underflow. As described above, the fine grains and the foreign matter are not sufficiently separated, and if the underflow is put into the steeping tank, the flow path may be clogged when the liquid is drained. Therefore, the underflow was not used for manufacturing of cornstarch.

About 300 kg of sulfur water (the sulfite concentration of water to 500 ppm to total weight) was added to the overflow. This combination was steeped for 4 hours with stirring by an agitator (small mixer A720 Satake of Chemical Industry Co) and kept at 50° C.

After steeping, the overflow was passed through a screen mesh (SW-ECO, circular vibrating sieve) to remove foreign matter. The mass of the removed foreign matter in terms of dry matter was 20 kg.

Thereafter, the overflow was washed with water, protein separated by centrifuge (Wanner Engineering Inc Co., Hydra-Cell), and further washed with water. The overflow was then dehydrated by centrifugal separator (Kokusan Co., upper discharge type centrifugal separator H-130E) and dried by a dryer (Espec Corp., a hot air dryer LC-114). Obtained cornstarch was 18 kg.

### Comparative Example 3

In the same manner as in Example 1, a first fraction (46 kg) and a second fraction (54 kg) was obtained from grain dust. About 51 kg of sulfur water (500 ppm sulfurous acid concentration relative to the total weight of the sulfur water) and the first fraction were added to stainless steel tanks of 500 L capacity and steeped for 48 hours at 50° C.

After steeping, the first fraction was ground with a grinder (QCG SYSTEMS LLC, Grinding Mill) and passed through a screen mesh (SW-ECO, circular vibrating sieve) to remove foreign matter. The dry matter-equivalent mass of the removed foreign matter was 24 kg.

Thereafter, the first fraction was washed with water, protein separated by centrifuge (Wanner Engineering Inc Co., Hydra-Cell), and further washed with water. The first fraction was then dehydrated by a centrifuge separator (manufactured by Kokusan Co., Ltd., upper discharge type centrifuge H-130E) and dried by a dryer (manufactured by Espec Co., Ltd., hot air dryer LC-114) to obtain 21 kg of cornstarch.

The second fraction was treated in the same manner as in Example 1 to obtain 31 kg of cornstarch. The dry matter-equivalent mass of the removed foreign matter was 21 kg. Cornstarch yield recovered from grain dust was 52% by weight relative to the total weight of the grain dust.

### Comparative Example 4

In the same manner as in Example 1, a first fraction (46 kg) and a second fraction (54 kg) was obtained from grain dust. The first fraction was removed as a foreign matter as it was without air separation. The second fraction was prepared in the same manner as in Example 1. Obtained cornstarch was 31 kg. Cornstarch yield recovered from grain dust was 31% by weight relative to the total weight of the grain dust.

### Example 2

In the same manner as in Example 1, a first fraction (46 kg) and a second fraction (54 kg) was obtained from grain dust. The second fraction was placed into a drum type magnet (Kanetec Co., Ltd., drum type magnetic separator KSD-HE300C). Thereafter, the amount of iron powder contained in the second fraction was 1.2 g, and the iron powder separation rate was 91% by mass.

### Comparative Example 5

In the same manner as in Example 1, a first fraction (46 kg) and a second fraction (54 kg) was obtained from grain dust. After the second fraction was steeped according to the method of Example 1, an in-line magnet (Kyowa stainless stock Association Inc., liquid line magnet filter) was used to separate iron powder. Thereafter, the amount of iron powder contained in the second fraction was 3.5 g, and the iron powder separation rate was 73% by mass.

In comparison to the 56 mass % of corn starch yield that was obtained in Example 1, the yield of corn starch in each of Comparative Examples 1-4 was lower. Further, in Examples 1 and 2 (i.e., in which the iron powder was separated before the second fraction was steeped in the sulfite-containing steeping liquid), the iron powder separation rate was as high as 91% by mass or more. In contrast, in Comparative Example 5 (i.e., in which iron powder was separated after the iron powder was separated), the iron powder separation rate was as low as 73%.

1. A method for producing corn starch, said method comprising the steps of:
a) sieving grain dust using a sieve, wherein the grain dust is sieved into a first fraction remaining on the sieve and a second fraction passing through the sieve,
b) dividing the first fraction using air separation, wherein the first fraction is separated into granules and pericarp,
c) steeping the granules in a first steeping water,
d) separating iron powder from the second fraction using a first magnetic separator,
e) steeping the second fraction in a second steeping water, and
f) combining the granules after step c) and the second fraction after step e)
g) removing foreign matter from the combination of step f),
wherein the combination after step g) is used to produce corn starch.

2. The method of claim 1, wherein the sieve comprises a mesh size of 0.8 mm to 1.4 mm.

3. The method of claim 1, wherein the grain dust is corn dust.

4. The method of claim 1, wherein the first steeping water is a sulfuric acid-containing steeping water.

5. The method of claim 1, wherein the second steeping water is a sulphite-containing steeping water.

6. The method of claim 1, wherein the first magnetic separator is selected from the group consisting of an electromagnetic separator, a drum magnet, a non-drum magnet, and any combination thereof.

7. The method of claim 1 further comprising a step of separating iron powder from the second fraction after step e) using a second magnetic separator.

8. The method of claim 7, wherein the second magnetic separator is selected from the group consisting of an electromagnetic separator, a drum magnet, a non-drum magnet, and any combination thereof.

9. The method of claim 1 further comprising a step of removing protein from the combination of step f).

10. The method of claim 1 further comprising a step wherein one or more of washing, dehydrating, and drying is performed on the combination of step g).

11. A method for producing corn starch, said method comprising the steps of:
a) selecting corn, wherein the selecting provides whole corn and grain dust,
b) sieving the grain dust using a sieve, wherein the grain dust is sieved into a first fraction remaining on the sieve and a second fraction passing through the sieve,
c) dividing the first fraction using air separation, wherein the first fraction is separated into granules and pericarp,
d) steeping the granules in a first steeping water,
e) separating iron powder from the second fraction using a first magnetic separator,
f) steeping the second fraction in a second steeping water, and
g) combining the granules after step c) and the second fraction after step f)
h) removing foreign matter from the combination of step g),
wherein the combination after step h) is used to produce corn starch.

12. The method of claim 11, wherein foreign matter is removed from the whole corn after step a).

13. The method of claim 11, wherein the whole corn and the grain dust are combined after step c).

14. The method of claim 11, wherein the sieve comprises a mesh size of 0.8 mm to 1.4 mm.

15. The method of claim 11, wherein the first steeping water is a sulfuric acid-containing steeping water.

16. The method of claim 11, wherein the second steeping water is a sulphite-containing steeping water.

17. The method of claim 11, wherein the first magnetic separator is selected from the group consisting of an electromagnetic separator, a drum magnet, a non-drum magnet, and any combination thereof.

18. The method of claim 11 further comprising a step of separating iron powder from the second fraction after step f) using a second magnetic separator.

19. The method of claim 18, wherein the second magnetic separator is selected from the group consisting of an electromagnetic separator, a drum magnet, a non-drum magnet, and any combination thereof.

20. The method of claim 1 further comprising a step wherein one or more of washing, dehydrating, and drying is performed on the combination of step h).
